(19) United States
(12) Patent Application Publication
(10) Pub. No.: US 2010/0303301 A1
(43) Pub. Date: Dec. 2, 2010

(54) Inter-Frame Motion Detection

(76) Inventor: Gregory Micheal Lamoureux, New Liskeard (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/475,832

(22) Filed: Jun. 1, 2009

(51) Int. Cl. G06K 9/00

(52) U.S. Cl. 382/107

(57) ABSTRACT

Methods and systems for detecting motion depicted in a sequence of frames are disclosed. One example method includes estimating a direction and a velocity of the depicted motion. Estimating the velocity includes evaluating velocities in a first range of velocities and evaluating velocities in a second range of velocities if a sufficiently reliable velocity estimate is not found in the first range of velocities.

### THE FIELD OF THE INVENTION

Embodiments of the invention relate to detecting motion depicted in a sequence of digital video frames (i.e., frames). More specifically, disclosed embodiments relate to methods, devices, and computer-readable media for detecting inter-frame motion.

### BACKGROUND

Detecting motion in digital video can be used in connection with a variety of image processing applications. For example, inter-frame motion detection can be used in connection with addressing blur that is perceived by the human eye when viewing the motion on a hold-type display, such as a liquid crystal display. However, detection of inter-frame motion is often difficult to perform quickly and accurately. The difficulty is compounded when motion occurs in various sections of a frame at different velocities and/or in an unknown direction.

### SUMMARY OF EXAMPLE EMBODIMENTS

In general, example embodiments relate to methods, devices, and computer-readable media for detecting inter-frame motion in digital video frames. Example embodiments can be used in conjunction with a variety of image processing applications, including correction of perceived blur applications to produce digital video frames in which perceived blur is minimized.

In a first example embodiment, a method for detecting motion depicted in a sequence of frames is disclosed. The example method includes a step of estimating a direction and a velocity of the depicted motion. The velocity estimation step includes, for example, evaluating velocities in a first range of velocities and evaluating velocities in a second range of velocities if a sufficiently reliable velocity estimate is not found in the first range of velocities.

In a second disclosed embodiment, a method for detecting motion depicted in a sequence of frames includes the step of identifying one or more motion sections in the sequence of frames. For each of the one or more motion sections a motion velocity is then determined. Identifying the motion velocity includes calculating a reliability measure for each of a plurality of candidate motion velocities.

In another embodiment, a method for detecting motion depicted in a sequence of frames includes comparing a first pixel of a first frame in the sequence with a second pixel of a second frame in the sequence. Typically, the first and second pixels having corresponding locations in their respective frames. Then the first and second pixels are compared to identify the pixels as either foreground pixels or background pixels. If the pixels are identified as foreground pixels the pixels can be used to characterize a motion depicted by the sequence of frames.

In yet another disclosed example embodiment, one or more computer-readable media have computer-readable instructions thereon which, when executed via a programmable processor, implement one or more of the methods for inter-frame motion detection discussed above.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further develop the above and other aspects of example embodiments of the invention, a more particular description of these examples will be rendered by reference to specific embodiments thereof which are disclosed in the appended drawings. It is appreciated that these drawings depict only example embodiments of the invention and are therefore not to be considered limiting of its scope. It is also appreciated that the drawings are diagrammatic and schematic representations of example embodiments of the invention, and are not limiting of the present invention. Example embodiments of the invention will be disclosed and explained with additional specificity and detail through the use of the accompanying drawings in which:

FIG. 1 discloses an example method for detecting inter-frame motion;

FIG. 2 is a schematic representation of an example video device;

FIG. 3 discloses an example method for performing an act in the method of FIG. 1;

FIG. 4 discloses a pair of frames being converted to bitonal images and the bitonal images being combined to generate a difference image;

FIG. 5 discloses an example data structure for recording a history of success or failure corresponding to different motion directions identified in the method of FIG. 1;

FIG. 6 discloses identification of motion section boundaries in a pair of bitonal images;

FIG. 7 discloses a portion of a frame that is known to have predetermined minimum motion section widths separated by buffers of a predetermined minimum width;

FIG. 8 discloses an example method for performing another act in the method of FIG. 1;

FIG. 9 discloses an example hierarchical arrangement of velocity ranges to be evaluated;

FIG. 10 discloses an example sampling scheme for identifying or estimating a motion velocity using block samples of a motion section;

FIG. 11 depicts estimation of a motion velocity in a close-up view of a pair of bitonal images;

FIG. 12 discloses a graph of example reliability measures for a range of motion velocities; and

FIGS. 13A and 13B show an example method for performing another act in the method of FIG. 1.

### DETAILED DESCRIPTION OF EXAMPLE EMBODIMENTS

In the following detailed description, reference is made to the accompanying drawings that show, by way of illustration, example embodiments of the invention. In the drawings, like numerals describe substantially similar components throughout the several views. These embodiments are described in sufficient detail to enable those skilled in the art to practice the invention. Other embodiments may be utilized and structural, logical and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

In general, example embodiments relate to methods, devices, and computer-readable media for detecting inter-frame motion in a sequence of digital video frames. Example embodiments can be used in conjunction with a variety of image processing applications, including correction of perceived blur applications to produce digital video frames in which perceived blur is minimized.

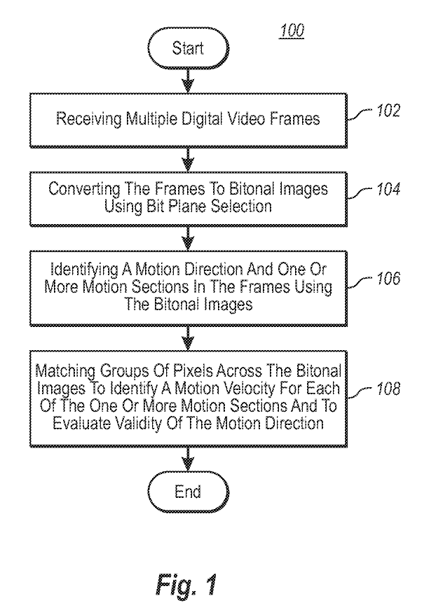

With reference now to FIG. 1, an example method 100 for detecting inter-frame motion is disclosed. The example method 100 identifies one or more motion sections in a sequence of frames and characterizes the motion—e.g., by determining a motion direction and velocity—for each motion section. The motion direction may initially be guessed and then updated depending on a reliability or confidence measure associated with the detected motion velocity. The motion velocity may be detected using a tiered range search in which a first range of velocities is evaluated and, if no sufficiently reliable motion velocity is detected, a second range of velocities is evaluated. Similarly, a third range may be evaluated if no sufficiently reliable motion velocity is found in the second range, and so on until either a sufficiently reliable motion velocity is found or all ranges have been evaluated.

The example method 100 and variations thereof disclosed herein can be implemented using computer-readable media for carrying or having computer-executable instructions or data structures stored thereon. Such computer-readable media can be any available media that can be accessed by a processor of a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store program code in the form of computer-executable instructions or data structures and which can be accessed by a processor of a general purpose or special purpose computer. Combinations of the above should also be included within the scope of computer-readable media.

Computer-executable instructions comprise, for example, instructions and data which cause a processor of a general purpose computer or a special purpose computer to perform a certain function or group of functions. Although the subject matter is described herein in language specific to methodological acts, it is to be understood that the subject matter defined in the appended claims is not necessarily limited to the specific acts described herein. Rather, the specific acts described herein are disclosed as example forms of implementing the claims.

Examples of special purpose computers include image processing devices such as digital camcorders, digital video displays, or portable movie players, or some combination thereof, or a digital camera/camcorder combination. An image processing device may include an inter-frame motion detection capability, for example, to detect inter-frame motion in a sequence of video frames. For example, a video display and/or capture device (i.e., a video device), such as a camcorder, with this inter-frame motion detection capability might include one or more computer-readable media that implement the example method 100. Alternatively, a computer connected to the video device could include one or more computer-readable media that implement the example method 100.

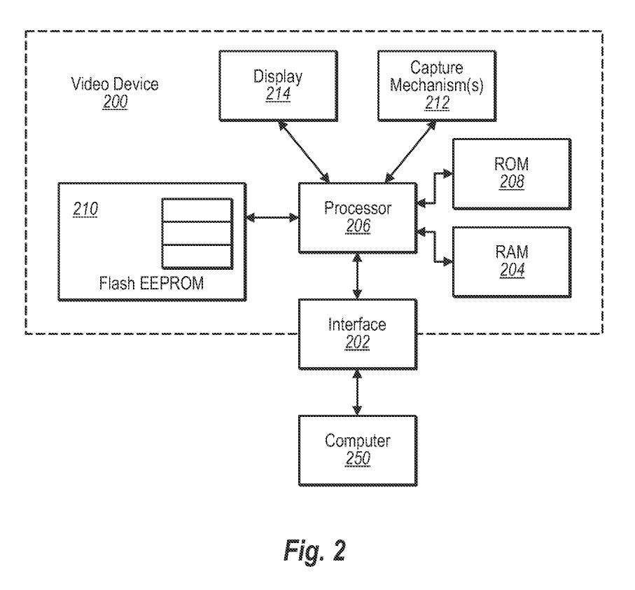

While any one of a number of different image processing schemes and applications might be used, one example of a video device, denoted at 200, is schematically represented in FIG. 2. In this particular implementation, the example video device 200 exchanges data with a host computer 250 by way of an intervening interface 202. Application programs and a video device driver may also be stored for access on the host computer 250. When a video retrieve command is received from the application program, for example, the video device driver controls conversion of the command data to a format suitable for the video device 200 and sends the converted command data to the video device 200. The driver also receives and interprets various signals and data from the video device 200, and provides necessary information to the user by way of the host computer 250.

When data is sent by the host computer 250, the interface 202 receives the data and stores it in a receive buffer forming part of a RAM 204. While other storage arrangements could be used, in one embodiment the RAM 204 can be divided into a number of sections, for example through addressing, and logically allocated as different buffers, such as a receive buffer or a send buffer. Data, such as digital video data, can also be obtained by the video device 200 from an optional capture mechanism(s) 212, the flash EEPROM 210, or the ROM 208. For example, the capture mechanism(s) 212, if present, can generate a sequence of digital video frames. This sequence of frames can then be stored in the receive buffer or the send buffer of the RAM 204.

A processor 206 executes computer-executable instructions stored on a ROM 208 or on a flash EEPROM 210, for example, to perform a certain function or group of functions, such as the method denoted at 100 for example. Where the data in the receive buffer of the RAM 204 is a sequence of digital video frames, for example, the processor 206 can implement the methodological acts of the method 100 on the sequence of frames to detect motion in various motion sections of the frames. Further processing in a video processing pipeline may then be performed on the sequence of frames before the video is displayed by the video device 200 on a display 214, such as an LCD panel for example, or transferred to the host computer 250, for example.

The example method 100 for detecting inter-frame motion in a sequence of digital video frames will now be discussed in connection with FIG. 1. Prior to performing method 100, an input sequence of frames can be targeted for various processing operations including inter-frame motion detection. The targeted input frames might be digital color images. Various image processing techniques can be applied to the targeted frames before method 100 is performed.

At 102, an act of receiving multiple digital video frames is performed. In the example embodiments described herein, the method 100 operates on two consecutive frames at a time, referred to as frame n and frame n+1. However, other embodiments of the method are contemplated in which more than two frames are operated on at a time or in which non-consecutive frames are used to detect inter-frame motion.

At 104, an act of converting the frames to bitonal images using bit plane selection is performed. Compression of the frames to bitonal images results in faster memory access, and calculation efficiency can be gained while reducing computation time for subsequent operations performed on the frames. One example of a bit plane selection process to convert frames to bitonal images is described in co-pending U.S. patent application Ser. No. ______ (Attorney Docket No. EETP105), titled “SYSTEM AND METHOD FOR GLOBAL INTER-FRAME MOTION DETECTION IN VIDEO SEQUENCES,” filed ______, the disclosure of which is incorporated herein by reference in its entirety.

At 106, an act of identifying a motion direction and one or more motion sections in the frames may be performed using the bitonal images produced in act 104. In the example embodiments described herein, the motion sections are assumed to all be moving in the same direction but may be moving at different speeds, including both positive and negative speeds. To identify the one or more sections, a difference image with respect to the bitonal images corresponding to two frames may be determined. Regions or sections of motion can be detected by examining the differences between the two frames.

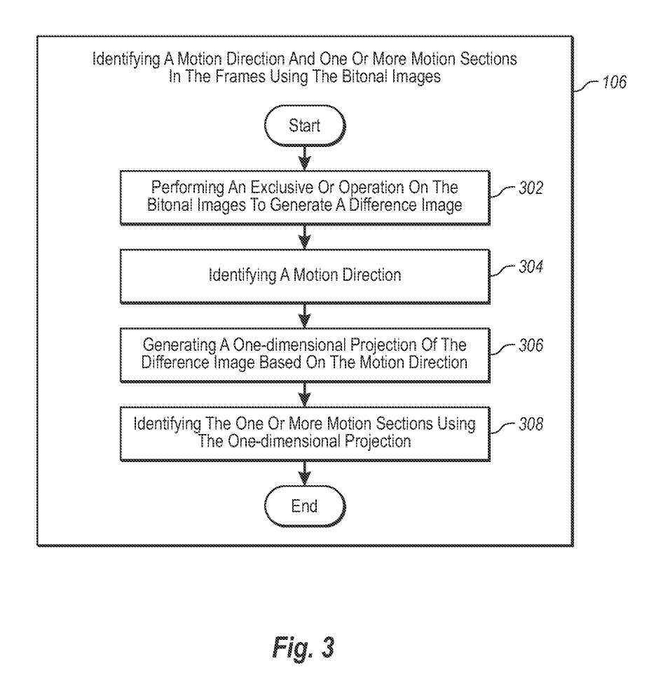

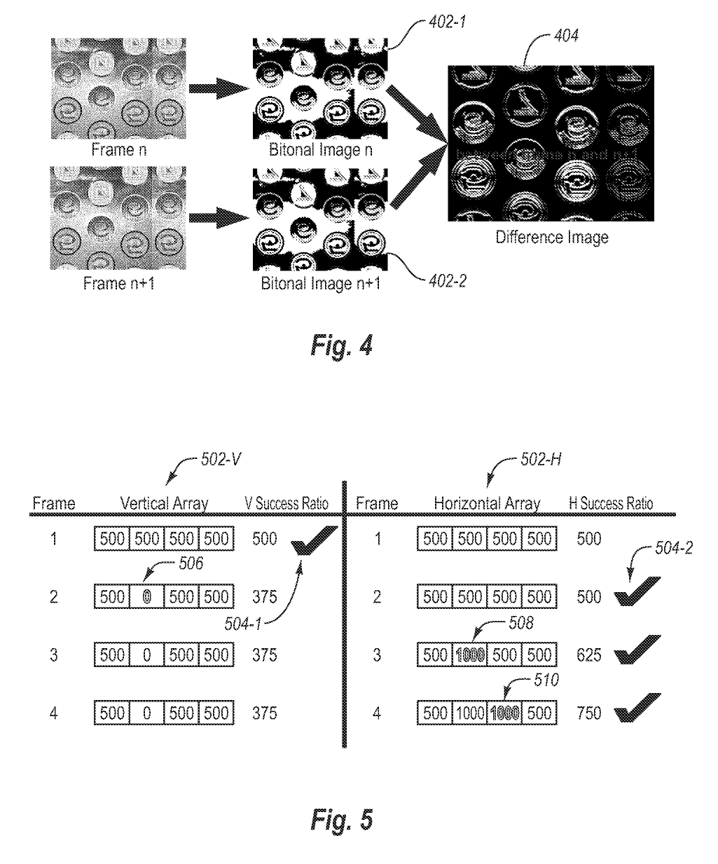

FIG. 3 discloses one example of steps that might be used for performing the act 106, i.e., identification of the motion direction and one or more motion sections in the frames. Referring to FIG. 3, at 302 an exclusive OR (XOR) operation is performed on the bitonal images to generate a difference image. FIG. 4 shows how an example pair of frames might be converted to bitonal images 402-1 and 402-2 at act 104 and then combined by an XOR operation at act 302 to generate a difference image 404. The XOR operation may be a byte-wise operation performed on individual bytes of the bitonal image pixel intensity values.

Referring again to FIG. 3, at 304 an act of identifying a motion direction is performed. The act of identifying a motion direction may be based at least in part on a history of previously tested motion directions with an initial motion direction being guessed or deduced from a difference image corresponding to an initial pair of frames.

FIG. 5 discloses an example data structure 500 for recording a history of success or failure of different motion directions. The identification of motion direction may be based at least in part on the history stored by the data structure 500. The data structure 500 can include an array for each possible motion direction. In the example shown, only two directions are possible, namely, vertical and horizontal, with corresponding arrays 502-V and 502-H. The possible directions may be limited to two if, for example, the direction of motion in the received digital frames is known a priori to be only either vertical or horizontal with respect to the frames' orientation. If other motion directions are expected, however, the data structure 500 may be appropriately expanded to include arrays for additional motion directions.

Each direction array 502 has a plurality of entries that may be initialized to a neutral validity value. In the example shown, validity values may range from zero to one thousand, where zero negates the associated direction's validity, one thousand confirms the associated direction's validity, and five hundred is neutral. Other validity value ranges (e.g., ranging from zero to one) may be used in accordance with the constraints and objectives of particular implementations. A motion direction may be assumed to be valid or invalid based on an average of the validity values in the arrays 502-V and 502-H. The average validity values corresponding to each direction are in columns labeled V Success Ratio and H Success Ratio.

Because the arrays 502-V and 502-H are, according to one embodiment, filled with neutral values initially, the success ratios for each direction are equal and neither direction is preferred over the other. Thus, either direction may be assumed as the correct one initially. In FIG. 5 the vertical direction is assumed to be correct as an initial guess. The preference for the vertical direction is indicated by a check mark 504-1 in the first row under the V Success Ratio column. The validity of the vertical direction is then negated by an entry of zero at 506 in the vertical array 502-V. An entry of zero at 506 may be based on an inability to find a sufficiently reliable motion velocity for a section when the direction of motion is assumed to be vertical. By virtue of the zero entry at 506, the average of entries in the horizontal array 502-H is greater than the average of entries in the vertical array 502-V and the motion direction is assumed to be horizontal for motion velocity detection in subsequent frames. The preference for a horizontal motion direction is indicated by a check mark 504-2 in the second row under the H Success Ratio column.

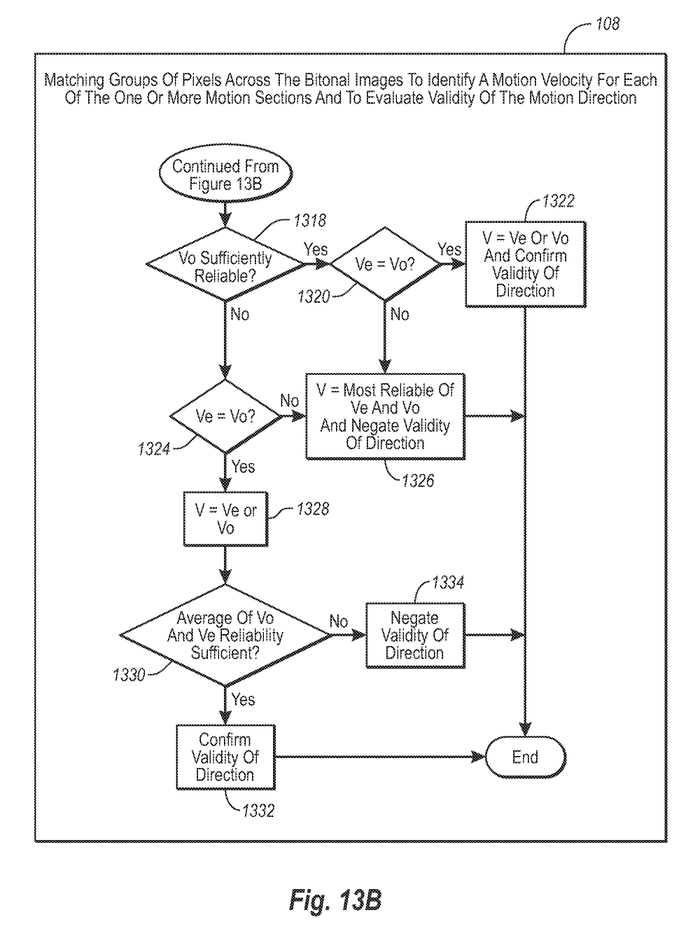

As motion velocity detection is performed for subsequent pairs of frames, the H Success Ratio continues to increase as the horizontal motion direction is increasingly confirmed as being most valid. The confirmation of validity is shown by entry of a high validity value (e.g., one thousand) at 508 and 510 after detection of reliable motion velocities in succeeding pairs of frames. The determination of whether to negate or confirm a direction is discussed in more detail below with reference to FIG. 13B.

The amount of historical data used to determine a motion direction may be set according to the size of each direction array 502-V and 502-H. In FIG. 5, each array has four entries and, accordingly, the motion direction for a particular frame is determined based on motion directions used for detection of motion velocity in the previous four frames. It will be appreciated that the number of historical entries serving as a basis for identifying a motion direction may be increased or decreased as desired for a particular implementation.

Referring again to FIG. 3, at 306 a one-dimensional projection of the difference image 404 is generated based on the motion direction identified at 304. Before obtaining the one-dimensional projection, the difference image 404 may undergo dilation, erosion, and/or other filtering operations to reduce noise. The one-dimensional projection may be obtained by performing an OR operation on individual lines of pixel intensity values oriented in the direction of motion identified at act 304. Thus, if one or more pixel intensity values in one of the lines is non-zero, the one-dimensional projection value for that line will be non-zero. Conversely, the projection value for a line having all zero intensity values will be zero.

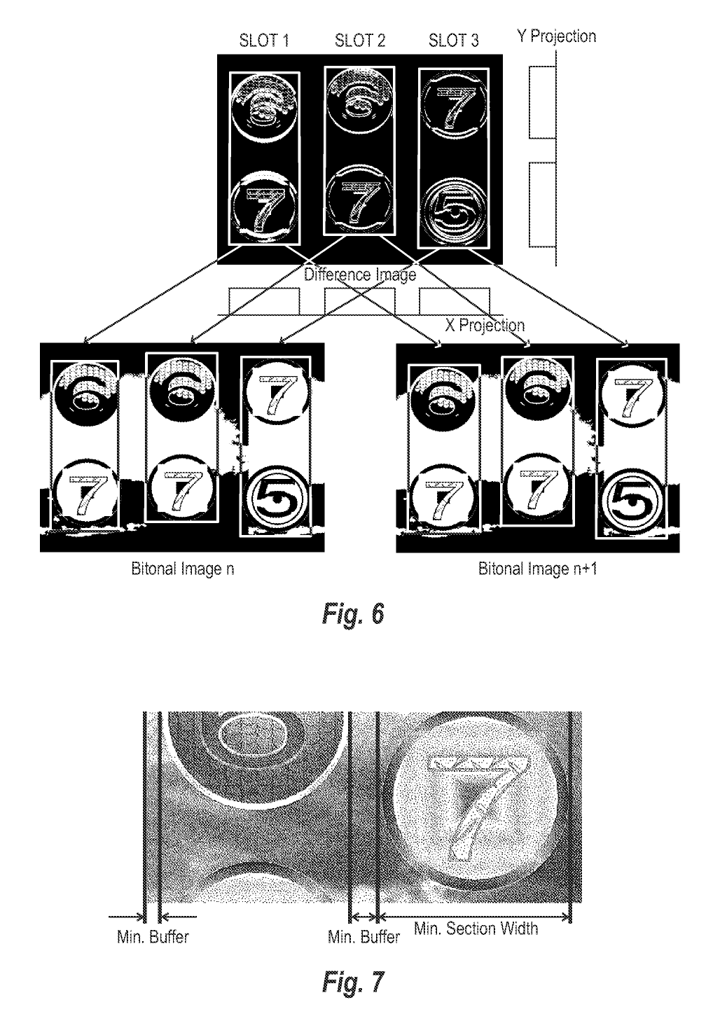

FIG. 6 depicts an example X-projection (for a vertical motion direction) and an example Y-projection (for a horizontal motion direction) of an example difference image. The one-dimensional projection may be an array having a plurality of entries. The number of entries will correspond to a frame dimension that is perpendicular to the motion direction.

Referring again to FIG. 3 at 308, identifying the one or more motion sections may be performed using the one-dimensional projection. The one-dimensional projection array corresponding to the difference image projection in the previously identified motion direction identifies boundaries between non-motion and motion sections in a first dimension. In addition, each motion section's boundaries in a second dimension perpendicular to the first dimension may optionally be identified using a one-dimensional projection array corresponding to the difference image projection in a direction perpendicular to the previously identified motion direction. FIG. 6 graphically discloses identification of motion section boundaries according to this technique in the bitonal images n and n+1.

Additional techniques may be used to identify motion sections based on knowledge of motion section features. For example, if information about the dimensions of motion sections and non-motion sections is known a priori, false positive detection may be reduced.

FIG. 7 discloses a portion of a frame that is known to have predetermined minimum motion section widths separated by buffers of a predetermined minimum width. Motion sections that have a smaller width can be identified as false positives. Moreover, one or both motion sections that neighbor a smaller buffer width can be identified as false positives. The predetermined minimum buffer width between motion sections may differ from a predetermined minimum buffer width between a motion section and a frame boundary.

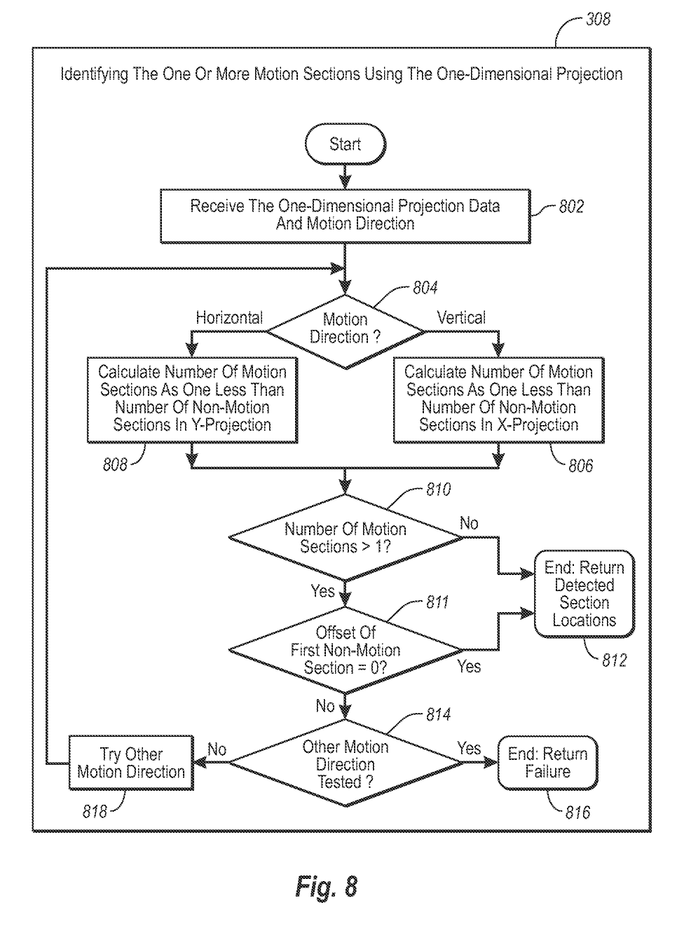

FIG. 8 discloses one example of a series of steps for carrying out act 308, i.e., identifying the one or motion sections using the one-dimensional projection. In the example method shown, knowledge about the motion sections is known a priori. For example, it may be known that the frames include more than one motion section each moving in either a horizontal or vertical direction. It may also be known that the motion section(s) are offset from the frame boundaries by a non-motion section.

At 802, the one-dimensional projection data and motion direction are received. At 804, a decision is made to follow one set of acts if the motion direction is horizontal and another set of acts if the motion direction is vertical. If the motion direction is vertical, at 806 a number of motion sections is calculated by determining a number of non-motion sections in the X-projection (e.g., by identifying discontinuities in the projection) and subtracting one from the result. Similarly, if the motion direction is horizontal, at 808 a number of motion sections are calculated by determining a number of non-motion sections in the Y-projection and subtracting one from the result. Next, at 810, it is determined whether a number of motion sections identified are greater than one and at 811 it is determined whether the first non-motion section has an offset of zero pixels from the frame boundary. If both conditions at 810 are met the motion section locations are identified and returned at 812. Alternatively, if the first condition at 810 is not met—e.g., the number of motion sections is equal to one—the motion section location is identified and returned at 812. Otherwise, at 814, the other motion direction is tested as a possible motion direction. If both directions fail to meet the conditions at 810 and 811 then a failure condition is returned at 816.

Referring again to FIG. 1, at step 108 an act of matching groups of pixels across the bitonal images generated at 104 is performed to identify a motion velocity for each of the one or more identified motion sections and to evaluate validity of the motion direction identified by act 106. The motion velocity may be an estimated velocity identified by evaluating a first range of velocities and then evaluating another range of velocities if no sufficiently reliable estimate is found in the first range. Various ranges can be evaluated according to a hierarchical or prioritized sequence. When a sufficiently reliable estimate is found, the evaluation of any lower priority ranges might be omitted to preserve computing resources and increase efficiency.

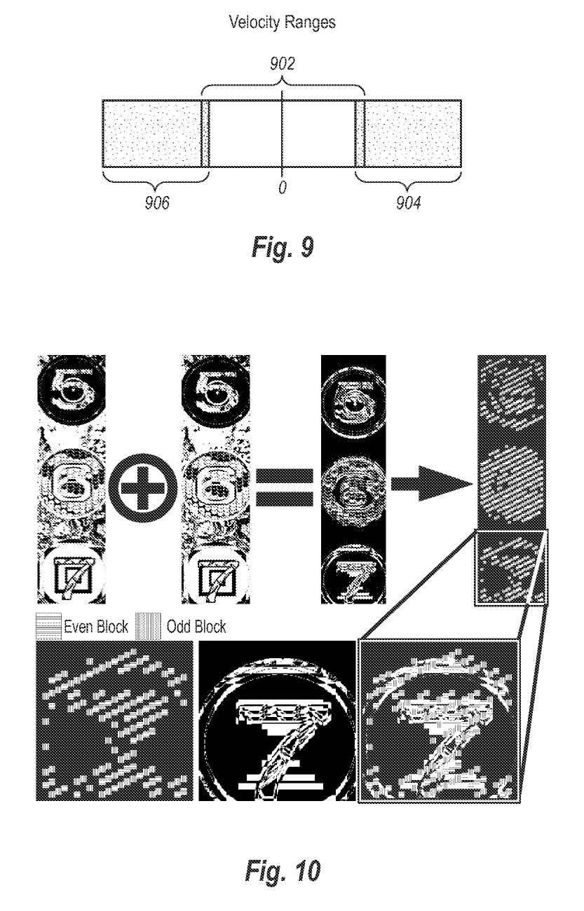

FIG. 9 discloses one example of a hierarchical arrangement of velocity ranges to be evaluated. A first range 902, including velocities at and close to zero, might first be evaluated. A second range 904 of positive velocities higher than the first range 902 can then be evaluated, if necessary, and then a third range 906 of negative velocities lower than the first range 902 can be evaluated, if necessary. The foregoing arrangement of velocity ranges and order of priority is just one example. One of ordinary skill in the art will appreciate that other embodiments might include different ranges, such as fewer or more ranges arranged in different ways, and different orders of evaluation priority.

Motion velocity may be measured in units of pixels per frame (ppf). Thus a particular motion section in which pixels are shifted χ pixels from one frame to the next can be said to have a velocity of χ (or −χ, as the case may be) ppf. Moreover, ranges may overlap each other or evaluation of a range may include evaluation of velocities near one or both of the range's outer limits. Evaluation of one or more velocities just outside the range can occur when an upper or lower limit of a range is determined to be a most reliable velocity estimate in the range and can be done to confirm that a nearby velocity is not a more reliable estimate.

In addition to improving computational efficiency using hierarchical velocity ranges, efficiency may be improved by estimating motion velocity using sampled portions of the bitonal images.

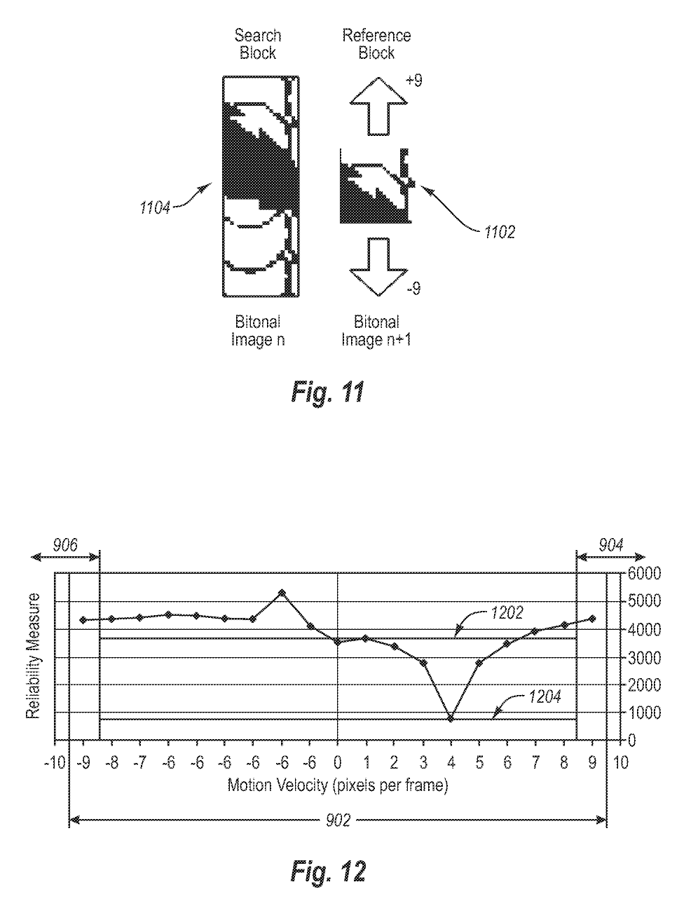

FIG. 10 discloses an example sampling scheme for identifying or estimating a motion velocity using block samples of a motion section. As described above in connection with FIG. 3, an XOR operation can be performed on bitonal images corresponding to video frames to generate a difference image. FIG. 10 depicts the XOR operation for a single motion section. In the difference image, select regions or blocks (i.e., groups of pixels) can be identified. As more fully discussed in connection with FIGS. 11, 12, 13A, and 13B below, blocks in corresponding locations of one or both of the bitonal images can be used to estimate the motion velocity by, for example, shifting a block in one of the bitonal images in the identified motion direction and determining a number of differences between the shifted block and an unshifted block in the other of the bitonal images.

The selection of sample blocks might be performed based on competing criteria such as accuracy and computational efficiency. For example, to improve efficiency while preserving sufficient accuracy, one block per ‘n’ blocks in each row may be included in the set of sample blocks. Moreover, each row of blocks can be offset from another row by ‘m’ pixels. The separation amounts ‘n’ and ‘m’ can be adjusted or set to predetermined levels as necessary to comply with desired criteria, such as computational efficiency and accuracy of detection, among other things. A block size may also be adjusted or set to a predetermined size for compliance with similar criteria. In one example embodiment, acceptable performance can be achieved if the blocks are eight by eight pixels in size, each row of blocks is offset from each other by four (m=4) pixels, and blocks in each row are four blocks (n=4) apart.

To reduce unnecessary computations, the sample blocks in a motion section might also be divided into different identifiable sets, thus forming a plurality of subsections in the motion section. Consequently, an initial velocity estimate may be performed using fewer than the full set of sample blocks, thereby narrowing a range of candidate velocities without processing the full set of sample blocks. The division of sample blocks can be any suitable division scheme that provides each subsection with a representative sample of motion section blocks. For example, alternating blocks in each row can be assigned to different subsections, thereby forming an even subsection and an odd subsection.

To further reduce unnecessary block matching comparisons, background blocks may be identified and eliminated from the set of sample blocks before, or as an initial stage of, velocity estimation. The background blocks can be identified by comparing pixel intensity characteristics of blocks having corresponding locations or coordinates in each of a pair of bitonal images. Thus, the block comparison might initially assume an inter-frame motion velocity of zero. The compared blocks can be identified as background blocks if their pixel intensity characteristics substantially match. A match can be determined by calculating a sum of pixel intensity differences and determining if the sum is zero or substantially close to zero. After this initial background block eliminating stage, candidate velocity evaluations for the motion section can be based on foreground (i.e., non-background) blocks.

FIG. 11 depicts estimation of motion velocity in a close-up view of a pair of bitonal images. One of the bitonal images can be designated as a reference image having a reference block 1102 and the other can be designated as a search image having a search block 1104. It will be appreciated that although bitonal image ‘n’ is designated as a search image and bitonal image n+1 as a reference image in FIG. 11, an opposite designation might instead be used. Given a motion direction, foreground blocks of pixels from the reference bitonal image, such as reference block 1102, can be shifted or displaced along the motion direction by a positive or negative displacement amount and compared to blocks of pixels within search blocks, such as search block 1104 of the search bitonal image. A close match tends to indicate that a velocity corresponding to the reference blocks' displacement is a good or reliable velocity estimate.

The reference blocks' displacement amount might range from a lower limit to an upper limit within a velocity range. In the example blocks shown in FIG. 11, the velocity range extends from −9 ppf to +9 ppf, corresponding to the range 902 in FIG. 9. Because the bitonal images n and n+1 correspond to consecutive frames, the displacement amount ranges from −9 pixels to +9 pixels. However, the range of displacement amounts can be appropriately extended for a comparison of non-consecutive frames. As the reference blocks are shifted and compared to search blocks, a reliability measure can be calculated for the candidate velocity corresponding to each shift.

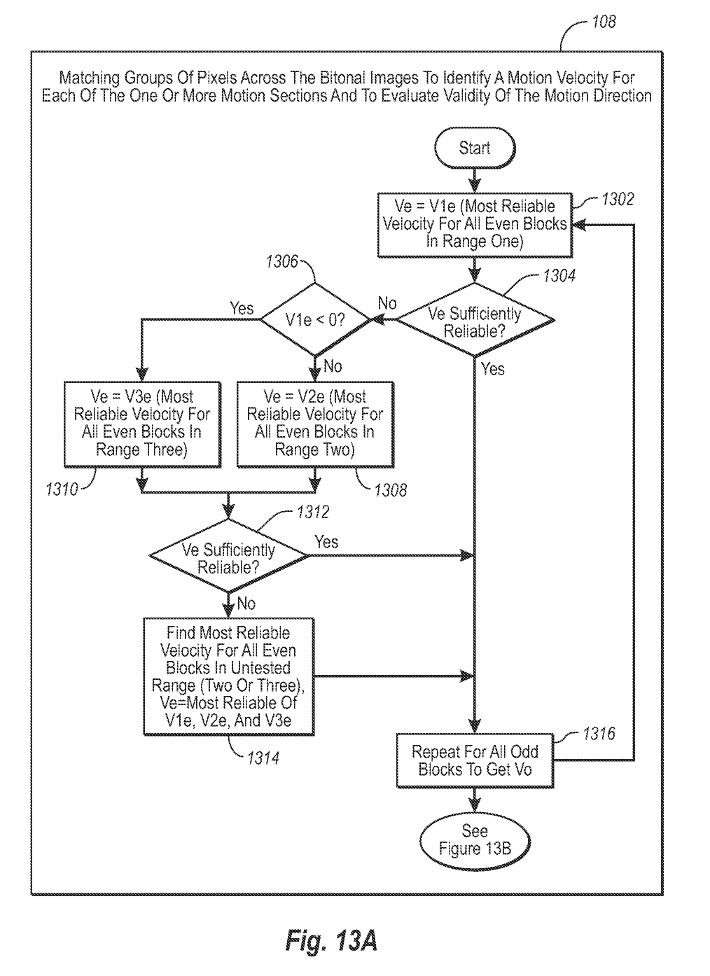

FIG. 12 discloses a graph of example reliability measures for a range of motion velocities extending from −9 ppf to 9 ppf (e.g., range 902). A reliability measure can be calculated for each candidate velocity by summing a total number of mismatching pixel intensities between shifted reference blocks in a reference bitonal image and unshifted blocks in corresponding locations of the search bitonal image. A candidate velocity having a low number of differences relative to other candidate velocities indicates a high reliability.

To determine if a reliability measure is sufficiently reliable to omit evaluation of lower priority velocity ranges, a candidate velocity's reliability measure can be compared to an average reliability measure of the corresponding range. A line 1202 is drawn at an average value of the reliability measures in the velocity range 902 and a line 1204 is drawn at the lowest reliability measure in the range, corresponding to the most reliable velocity—four ppf—in the range. The most reliable velocity in the range is considered sufficiently reliable to terminate further range evaluations if the lowest reliability measure line 1204 is lower than the average reliability measure line 1202 by a threshold amount.

FIGS. 13A and 13B show one example of a series of steps for carrying out act 108, i.e., an act of matching groups of pixels across the bitonal images to identify a motion velocity for each of the one or more identified motion sections and to evaluate validity of the motion direction. The example method of FIGS. 13A and 13B includes one or more of the acts outlined above in connection with FIGS. 9-12.

At 1302, a first velocity range can be evaluated to find a good motion velocity estimate using an even subsection of blocks (i.e., the evenly numbered alternating blocks) in a pair of bitonal images. A velocity estimate for the even subsection (i.e., Vₑ) can be set to a most reliable velocity identified in the first velocity range using the even subsection blocks (i.e., V₁ₑ). The most reliable velocity can be determined by comparing reliability measures, such as a sum of absolute differences, associated with each velocity in the range.

At 1304, it is determined whether the even velocity estimate Vₑ is sufficiently reliable. Sufficient reliability can be determined by comparing Vₑ to a standard, such as an average of reliability measures for all of or a majority of the velocities in the range. An average of the reliability measures for a range may be an average sum of absolute differences (ASAD) calculated according to the following formula:

$$A S A D = ( \frac{{\sum }_{i = R min}^{R max} {E}_{V ( i )}}{R max - R min + 1} )$$

where Rmin and Rmax are minimum and maximum velocities in the range, respectively, and E_{V(i)} is a sum of absolute differences for a velocity with index i. Alternatively, the Rmin value may be one ppf lower than the minimum velocity in the range and the Rmax value may be one ppf higher than the maximum velocity in the range.

The even velocity estimate Vₑ is sufficiently reliable if a ratio of a reliability measure E_{Ve} of the even velocity estimate Vₑ to ASAD satisfies the following inequality:

$$[ \frac{{E}_{Ve}}{A S A D} < ( 1 - {T}_{1} ) ]$$

where E_{Ve} is a reliability measure, e.g., a sum of absolute differences, associated with the even velocity estimate Vₑ and T₁ is a predetermined or adjustable threshold value. The test for sufficient reliability might optionally include the following inequality as well:

[Rₘᵢₙ<Vₑ<Rₘₐₓ]

The condition that Vₑ be between Rₘᵢₙ and Rₘₐₓ can be imposed because a most reliable velocity estimate that is equal to a lower range limit (Rₘᵢₙ) or an upper range limit (Rₘₐₓ) frequently indicates a potential for finding an even more reliable velocity estimate just outside the range.

If Vₑ is determined not to be sufficiently reliable one or more other velocity ranges can be evaluated. First, however, at 1306, it is determined whether the most reliable estimate in the first range V₁ₑ is greater than or less than a middle value of the first range, which, in the example method shown, is zero. This determination can be made to save time by evaluating a range that is closest to V₁ₑ first. For example, if V₁ₑ is closer to a second range, the method can proceed to 1308 where a most reliable velocity for all even blocks in the second range (denoted V₂ₑ) is determined. Conversely, at 1310, the most reliable velocity for all even blocks in the third range (denoted V₃ₑ) is determined if V₁ₑ is closer to the third range. The even velocity estimate Vₑ can be set to either V₂ₑ or V₃ₑ, as the case may be, and, at 1312, Vₑ can be evaluated to determine whether it is sufficiently reliable to forego evaluating another range of velocities. The determination at 1312 can be similar to that described above in reference to the determination at 1304. If Vₑ is not sufficiently reliable, the method can proceed to 1314 and find the most reliable velocity for all even blocks in the remaining untested range, be it the second range or the third range. Then, the even velocity estimate Vₑ can be set to the most reliable Of V₁ₑ, V₂ₑ, and V₃ₑ.

At 1316 an odd velocity estimate Vₒ can be identified using the odd subsection of blocks in the pair of bitonal images according to the same process used to identify the even velocity estimate Vₑ. However, the velocity range in which Vₑ lies can be evaluated before evaluating other ranges. Thus, for example, if Vₑ lies in the second range, one or more of acts 1302 through 1314 might be modified to place evaluation of the second range before evaluation of the first range for determination of the odd velocity estimate Vₒ. Estimation of the odd velocity may proceed after a sufficiently reliable estimate of Vₑ is identified (at either of acts 1304 or 1312) or after all velocity ranges have been evaluated (at 1314), as the case may be.

Although Vₑ is determined before Vₒ in the method of FIG. 13A, the order of block subsection evaluation might vary. For example, the odd velocity estimate Vₒ can be obtained before the even velocity estimate Vₑ. Regardless of order, by getting the two velocity estimates Vₑ and Vₒ, a reliability of the identified motion direction can be gauged, as shown in the method acts of FIG. 13B.

After obtaining velocity estimate Vₒ, a reliability measure of Vₒ can be evaluated at 1318. The reliability evaluation can be implemented as described above with reference to the reliability evaluation at 1304 and 1312, but with Vₒ substituted for Vₑ. Thus, the reliability of Vₒ can be considered sufficient if the following inequality is satisfied:

$$[ \frac{{E}_{Vo}}{A S A D} < ( 1 - {T}_{1} ) ]$$

where E_{Vo} is a reliability measure, e.g., a sum of absolute differences, associated with the odd velocity estimate Vₒ and T₁ is the predetermined or adjustable threshold value used to measure reliability of Vₑ. The test for sufficient reliability might also include the following inequality:

[Rₘᵢₙ<Vₒ<Rₘₐₓ]

If the reliability evaluation at 1318 indicates Vₒ is sufficiently reliable, a check can then be performed at 1320 to determine whether Vₑ equals Vₒ. If both estimates are equal then at 1322 the motion velocity of the motion section under consideration (i.e., V) is identified as either Vₑ or Vₒ and a validity of the identified motion direction is confirmed. If, on the other hand, Vₑ does not equal Vₒ at 1320 the act at 1326 can be performed in which V may be identified as the more reliable of Vₑ and Vₒ, based on their respective reliability measures, and a validity of the motion direction can be negated. Confirming or negating validity of the motion direction will result in an update to the appropriate array 502-V or 502-H described above in connection with FIG. 5 after all motion sections in a frame have been evaluated. For example, if a majority of motion sections confirm the validity of a vertical motion direction then an entry in the array 502-V for that frame can be increased. If half of the motion sections confirm the validity and half negate then no updating may occur. The updating of an entry in array 502-V or 502-H can in turn, depending on the other array entries, cause a change in the identified motion direction for a next set of frames to be evaluated.

If, at 1318, it is determined that Vo is not sufficiently reliable, a check of whether Ve equals Vo can be performed at 1324. Although the check at 1324 is the same check performed at 1320, different consequences can result from each checking act. If, at 1324, it is determined that Ve does not equal Vo, the act at 1326 is performed in which V is chosen as the more reliable of Ve and Vo and the motion direction validity is negated. However, if at 1324 it is determined that Ve equals Vo, a different set of consequences may result. Namely, at 1328 V can be set to either Ve or Vo and then, at 1330 an average of reliability measures corresponding to Ve and Vo can be evaluated. If the average reliability is sufficient, according to a threshold test outlined below, the validity of the motion direction is confirmed at 1332, but otherwise the validity is negated at 1334.

A threshold test applied at 1330 for determining whether the average reliability of Ve and Vo is sufficient can be similar to the threshold test applied at acts 1304 and 1312, but can be modified to take into account the additional candidate velocity evaluations. For example, the threshold test at 1330 might apply the following inequality:

$$[ \frac{( {E}_{Ve} + {E}_{Vo} ) / 2}{T A S A D} < ( 1 - {T}_{2} ) ]$$

where E_{Ve} and E_{Vo} are reliability measures associated with the even and odd velocity estimates Ve and Vo, respectively, T₂ is a predetermined or adjustable threshold (and may be the same as or different than the threshold T₁ applied in acts 1304 and 1312), and TASAD is a total average sum of absolute differences (or average of some other reliability measures) calculated as follows:

$$T A S A D = ( \frac{{\sum }_{n = 1}^{N V} {E}_{Vn}}{N V} )$$

where NV is a total number of individual velocities evaluated in all tested ranges and subsections and E_{Vn} is a reliability measure (e.g., a sum of absolute differences) for an evaluated velocity with index n.

The reliability determinations made in acts 1304, 1312, 1318, and 1330 apply thresholds T₁ and T₂. The thresholds can be predetermined (e.g., set by a user or factory set), adjustable by an end-user or technician, and/or automatically adaptive based on the particular qualities of an input video sequence and/or desired performance results. For example, the thresholds can be set differently according to different velocity range sizes or pixel resolution settings.

In addition to updating a motion direction validity, the method of FIGS. 13A and 13B may return a confidence measure for the identified velocity V based on confidence measures for one or both of Vₑ and Vₒ. The confidence measure can be used by a blur correction procedure to determine whether to address perceived blur in the associated motion section. If, for example, the confidence measure is below a predetermined threshold, the presence of blur can remain unaddressed to avoid the risk of making ill-advised blur corrections and causing worse effects than the presence of perceived blur. One way of calculating the confidence measure is according to the following confidence measure formulas for the even and odd subsections:

$$Even Subsection Confidence Measure = 1 - ( \frac{{E}_{Ve}}{N {B}_{e} \times N P} )$$

$$Odd Subsection Confidence Measure = 1 - ( \frac{{E}_{Vo}}{N {B}_{o} \times N P} )$$

where NBₑ and NBₒ are a number of foreground blocks sampled in the even and odd subsections, respectively, NP is a number of pixels in each block (same for each subsection), and E_{Ve} and E_{Vo} are the reliability measures for Vₑ and Vₒ, respectively. The confidence measure reported to a blur correction procedure can depend on which path is taken in the method of FIG. 13B. For example, if either of acts 1322, 1328 is reached the confidence measure can be an average of the even and odd subsection confidence measures. Otherwise, if act 1326 is reached, the confidence measure can be the largest of the even and odd confidence measures.

The foregoing example embodiments may be used to estimate global motion in one or more arbitrary separate sections of frames in a video sequence. The methods and techniques may be used in conjunction with methods for improving motion video quality on an LCD panel. In addition to the various alternative embodiments described above, various other versions of method 100 can be implemented including versions in which various acts are modified, omitted, or new acts added or in which the order of the depicted acts differ.

In one embodiment, for example, a motion direction can be identified without the aid of historical validity values and therefore act 108 can be modified to exclude evaluating validity of the motion direction. For example, the motion direction can be identified by comparing modified projections of a difference image, such as difference image 404. The projection of the difference image can be modified by performing an AND operation on pixel intensities of the difference image with the pixel intensities of each of the bitonal images to produce a first modified difference image D₁ and a second modified difference image D₂. Thus, the modified difference images D₁ and D₂ can be defined by the following formulas:

D₁(i)=[Xₙ(i)XOR Xₙ₊₁(i)]AND Xₙ(i)

D₂(i)=[Xₙ(i)XOR Xₙ₊₁(i)]AND Xₙ₊₁(i)

where i is a byte index and Xₙ and Xₙ₊₁ are bitonal images derived from frames with indices n and n+1, respectively, in a sequence of frames. When a one-dimensional projection of D₁ in a particular direction is substantially the same as a one-dimensional projection of D₂ in the same direction, then the direction in which the projections were made is likely to be the direction of motion. On the other hand, a difference in the motion section positions indicated by each projection signifies that the direction of the projections is not the motion direction. This technique for identifying motion direction can be used in place of or in combination with the historical success arrays described above in connection with FIG. 5.

The example embodiments disclosed herein may be embodied in other specific forms. The example embodiments disclosed herein are to be considered in all respects only as illustrative and not restrictive.

What is claimed is:

1. A method for detecting motion depicted in a sequence of frames, the method comprising:
estimating a direction and a velocity of the depicted motion,
wherein estimating the motion velocity includes:
evaluating velocities in a first range of velocities; and
evaluating velocities in a second range of velocities if a sufficiently reliable velocity estimate is not found in the first range of velocities.

2. The method as recited in claim 1, wherein the first range overlaps at least partially with the second range.

3. The method as recited in claim 2, further comprising:
evaluating velocities in the second range of velocities if a most reliable velocity found in the first range is within a portion of the first range that overlaps with the second range.

4. The method as recited in claim 1, wherein a velocity estimate is determined to be sufficiently reliable based on whether a reliability measure of the velocity estimate meets a threshold.

5. The method as recited in claim 4, wherein the reliability measure is calculating by summing a number of differences between a first block of pixels of a first frame image and a second block of pixels of a second frame image, the second region being spatially shifted with respect to the first region by a magnitude derived from the velocity estimate.

6. The method as recited in claim 1, wherein a velocity estimate is determined not to be sufficiently reliable if the velocity estimate is within a portion of the first range that overlaps with the second range.

7. The method as recited in claim 1, wherein estimating the motion velocity further includes evaluating velocities in a third range of velocities if a sufficiently reliable velocity estimate is not found in the second range of velocities.

8. A method for detecting motion depicted in a sequence of frames, the method comprising:
identifying one or more motion sections in the sequence of frames; and
for each of the one or more motion sections, identifying a motion velocity,
wherein identifying the motion velocity includes calculating a reliability measure for each of a plurality of candidate motion velocities.

9. The method of claim 8, wherein the one or more motion sections are identified by comparing consecutive frames in the sequence of frames.

10. The method of claim 8, wherein identifying the motion velocity further includes:
comparing a first region of a first frame image with a second region of a second frame image, the second region being displaced by a number of pixels corresponding to one of the candidate motion velocities,
wherein calculating the reliability measure of the candidate motion velocity includes determining a degree to which the first region matches the second region.

11. The method of claim 8, wherein the candidate motion velocities lie within a first range and wherein identifying the motion velocity includes:
identifying a most reliable candidate motion velocity in the first range based on reliability measures associated with each candidate motion velocity in the first range.

12. The method of claim 11, wherein identifying the motion velocity further includes:
evaluating the reliability measures of the motion velocities in the first range to determine whether the most reliable candidate motion velocity in the first range is sufficiently reliable; and
evaluating a second range of candidate motion velocities if the most reliable candidate motion velocity in the first range is not sufficiently reliable.

13. The method of claim 8, further comprising:
identifying a direction of motion for the one or more motion sections; and
changing the identified direction based on the reliability measures of the candidate motion velocities.

14. The method of claim 13, wherein the identified direction is changed if a most reliable one of the candidate motion velocities does not meet a reliability threshold.

15. The method of claim 14, further comprising:
identifying subsections in at least one section,
wherein calculating a reliability measure for each of a plurality of candidate motion velocities includes:
calculating reliability measures for the candidate motion velocities using a first one of the subsections and the identified direction; and
calculating reliability measures for the candidate motion velocities using a second one of the subsections and the identified direction, and
wherein the identified direction is changed if an average of a most reliable one of the reliability measures calculated using the first subsection and a most reliable one of the reliability measures calculated using the second subsection does not meet a reliability threshold.

16. The method of claim 8, further comprising:
converting at least a portion of the frames into bitonal images; and
identifying the plurality of motion sections using the bitonal images.

17. A method for detecting motion depicted in a sequence of frames, the method comprising:
comparing a first pixel of a first frame in the sequence with a second pixel of a second frame in the sequence, the first and second pixels having corresponding locations in their respective frames;
comparing the first and second pixels to identify the pixels as either foreground pixels or background pixels; and
using the pixels to characterize a motion depicted by the sequence of frames if the pixels are identified as foreground pixels.

18. The method of claim 17, further comprising:
converting the first and second pixels to bitonal pixels,
wherein comparing the first and second pixels includes comparing pixel intensities of the first and second bitonal pixels and identifying the pixels as foreground pixels if the pixel intensities differ.

19. One or more computer-readable media having computer-readable instructions thereon which, when executed, implement a method for detecting motion depicted in a sequence of frames, the method comprising the acts of:
estimating a direction of the depicted motion; and
estimating a velocity of the depicted motion,
wherein estimating the motion velocity includes:
evaluating velocities in a first range of velocities; and
evaluating velocities in a second range of velocities if a sufficiently reliable velocity estimate is not found in the first range of velocities.

20. A system for processing a sequence of frames based on motion detected in the frames, the system comprising:
a memory buffer configured to receive a plurality of frames;
a processing circuit configured to carry out the following acts:
estimating a direction of motion depicted in the frames;
estimating a velocity of the depicted motion,
wherein estimating the velocity of motion includes:
evaluating velocities in a first range of velocities; and
evaluating velocities in a second range of velocities if a sufficiently reliable velocity estimate is not found in the first range of velocities.

21. The system as recited in claim 20, wherein the processing circuit is further configured to modify the plurality of frames to minimize a perceived blur based on the estimated motion velocity and direction.
